(19) United States
(12) Patent Application Publication
(10) Pub. No.: US 2023/0214701 A1
(43) Pub. Date: Jul. 6, 2023

(54) METHOD AND APPARATUS FOR CONVERTING IMAGE USING QUANTUM CIRCUIT

(71) Applicant: SAMSUNG SDS CO., LTD., Seoul (KR)

(72) Inventors: Jeongwoo Jae, Seoul (KR); Jeonghoon Hong, Seoul (KR)

(21) Appl. No.: 18/091,940

(22) Filed: Dec. 30, 2022

(30) Foreign Application Priority Data
Jan. 6, 2022 (KR) 10-2022-0002370

(51) Int. Cl. G06N 10/20

(52) U.S. Cl. CPC G06N 10/20

(57) ABSTRACT

A method for converting an image using a quantum circuit includes generating an input quantum state corresponding to an original image, based on a pixel value of each pixel in the original image, transforming the input quantum state into a 1-level intermediate quantum state by applying a Y-axis rotation gate to two qubits, among a plurality of qubits representing the input quantum state, and transforming the 1-level intermediate quantum state into a 1-level output quantum state by applying a swap gate to a plurality of qubits representing the 1-level intermediate quantum state, the 1-level output quantum state being a state in which a 1-level sub-image quantum state, corresponding to each of a plurality of 1-level sub-images generated by applying Harr wavelet transformation to the original image, and a quantum state, corresponding to a label for the 1-level sub-image quantum state, are entangled with each other.

### CROSS-REFERENCE TO RELATED APPLICATION(S) AND CLAIM OF PRIORITY

This application claims the benefit under 35 USC § 119 of Korean Patent Application No. 10-2022-0002370 filed on Jan. 6, 2022, in the Korean Intellectual Property Office, the disclosure of which is incorporated herein by reference in its entirety.

### BACKGROUND

### 1. Field

Example embodiments relate to quantum computer technology.

### 2. Description of Related Art

Two-dimensional Haar wavelet transformation is often used to process classical images, as a tool for analyzing image components.

As the related art for two-dimensional quantum Haar wavelet transformation (2-DQHWT) performing such two-dimensional Haar wavelet transformation using a quantum circuit, a method of independently applying one-dimensional quantum Haar wavelet transformation (1-DQHWT) to each dimension of an image pixel two times has been proposed. However, in the related art, an operation between pieces of data present in different dimensions cannot be performed, so that when the 2-DQHWT is expanded to multiple levels, a circuit is not intuitively expanded. In addition, in the related art, there is no labeling function for a quantum state generated through 2-DQHWT, so that it is not possible to distinguish which of sub-images, decomposed through Harr wavelet transformation, the generated quantum state is a quantum state for.

### SUMMARY

An aspect of the present disclosure is to provide a method and an apparatus for converting an image using a quantum circuit.

According to an aspect of the present disclosure, a method for converting an image using a quantum circuit includes: generating an input quantum state corresponding to an original image, based on a pixel value of each pixel in the original image; transforming the input quantum state into a 1-level intermediate quantum state by applying a Y-axis rotation gate to two qubits, among a plurality of qubits representing the input quantum state; and transforming the 1-level intermediate quantum state into a 1-level output quantum state by applying a swap gate to a plurality of qubits representing the 1-level intermediate quantum state, the 1-level output quantum state being a state in which a 1-level sub-image quantum state, corresponding to each of a plurality of 1-level sub-images generated by applying Harr wavelet transformation to the original image, and a quantum state, corresponding to a label for the 1-level sub-image quantum state, are entangled with each other.

In the generating the input quantum state, the input quantum state may be generated through amplitude encoding based on a plurality of qubits corresponding to coordinates of each pixel and a pixel value of each pixel.

The plurality of 1-level sub-images may include a low-frequency image, a horizontal direction high-frequency image, a vertical direction high-frequency image, and a diagonal direction high-frequency image for the original image. A label for the 1-level sub-image quantum state may be a label for identifying whether the 1-level sub-image quantum state is a quantum state corresponding to which image among the low-frequency image, the horizontal direction high-frequency image, the vertical direction high-frequency image, and the diagonal direction high-frequency image.

The plurality of qubits representing the input quantum state may include a plurality of X-qubits, corresponding to X-axis coordinates of each pixel, and a plurality of Y-qubits corresponding to Y-axis coordinates of each pixel.

In the transforming the 1-level intermediate quantum state into the 1-level output quantum state, a state of each of one of the plurality of X-qubits and one of the Y-qubits may rotate by −π/2 about a Y-axis of a Bloch sphere.

In the transforming the 1-level intermediate quantum state into the 1-level output quantum state, a state of each of a last X-qubit, among the plurality of X-qubits, and a last Y-qubit, among the plurality of Y-qubits, may rotate by −π/2 about the Y-axis of the Bloch sphere.

The transforming the 1-level intermediate quantum state into the 1-level output quantum state may include: sequentially swapping states of adjacent X-qubits from the last X-qubit to a first X-qubit, among the plurality of X-qubits; sequentially swapping states of adjacent Y-qubits from the last Y-qubit to a first Y-qubit, among the plurality of Y-qubits; and swapping states of the first Y-qubit and the last X-qubit, and then sequentially swapping states of adjacent X-qubits from the last X-qubit to a second X-qubit, among the plurality of X-qubits.

The method may further include: transforming a k-level output quantum state (where k is a positive integer equal to or greater than 1) into a k+1 level intermediate quantum state by applying the Y-axis rotation gate to two qubits, among a plurality of qubits representing the k-level output quantum state; and transforming the k+1 level intermediate quantum state into a k+1 level output quantum state by applying the swap gate to a plurality of qubits representing the k+1 level intermediate quantum state, the k+1 level output quantum state being a state in which a k+1 level sub-image quantum state, corresponding to each of a plurality of k+1 level sub-images, and a quantum state, corresponding to a label for the k+1 level sub-image quantum state, are entangled with each other.

The method may further include: measuring a state of a label qubit representing a quantum state corresponding to a label for a k-level sub-image (where k is a positive integer equal to or greater than 1); determining whether a measured value of the label qubit is a preset value; transforming a k-level output quantum state into a k+1 level intermediate quantum state by applying the Y-axis rotation gate to two qubits, among a plurality of qubits representing the k-level output quantum state, when the measured value of the label qubit is the preset value; and transforming the k+1 level sub-image quantum state into a k+1 level output quantum state by applying the swap gate to a plurality of qubits representing the k+1 level intermediate state, the k+1 level output quantum state being a state in which a k+1 level sub-image quantum state, corresponding to a plurality of k+1 level sub-image, and a quantum state, corresponding to a label for the k+1 level sub-image quantum state, are entangled with each other.

According to another aspect of the present disclosure, an apparatus for converting an image using a quantum circuit includes: an encoding unit configured to generate an input quantum state corresponding to an original image, based on a pixel value of each pixel in the original image; a first transformation unit configured to transform the input quantum state into a 1-level intermediate quantum state by applying a Y-axis rotation gate to two qubits, among a plurality of qubits representing the input quantum state; and a second transformation unit configured to transform the 1-level intermediate quantum state into a 1-level output quantum state by applying a swap gate to a plurality of qubits representing the 1-level intermediate quantum state, the 1-level output quantum state being a state in which a 1-level sub-image quantum state, corresponding to each of a plurality of 1-level sub-images generated by applying Harr wavelet transformation to the original image, and a quantum state, corresponding to a label for the 1-level sub-image quantum state, are entangled with each other.

The encoding unit may generate the input quantum state through amplitude encoding based on a plurality of qubits, corresponding to coordinates of each pixel, and a pixel value of each pixel.

The plurality of 1-level sub-images may include a low-frequency image, a horizontal direction high-frequency image, a vertical direction high-frequency image, and a diagonal direction high-frequency image for the original image. A label for the 1-level sub-image quantum state may be a label for identifying whether the 1-level sub-image quantum state is a quantum state corresponding to which image among the low-frequency image, the horizontal direction high-frequency image, the vertical direction high-frequency image, and the diagonal direction high-frequency image.

The plurality of qubits representing the input quantum state may include a plurality of X-qubits, corresponding to X-axis coordinates of each pixel, and a plurality of Y-qubits corresponding to Y-axis coordinates of each pixel.

The first transformation unit may rotate a state of each of one of the plurality of X-qubits and one of the Y-qubits by −π/2 about a Y-axis of a Bloch sphere.

The first transformation unit may rotate a state of each of a last X-qubit, among the plurality of X-qubits, and a last Y-qubit, among the plurality of Y-qubits, by −π/2 about the Y-axis of the Bloch sphere.

The second conversion unit may sequentially swap states of adjacent X-qubits from the last X-qubit to a first X-qubit, among the plurality of X-qubits, sequentially swap states of adjacent Y-qubits from the last Y-qubit to a first Y-qubit, among the plurality of Y-qubits, and swap states of the first Y-qubit and the last X-qubit, and then sequentially swap states of adjacent X-qubits from the last X-qubit to a second X-qubit, among the plurality of X-qubits.

The first transformation unit may transform a k-level output quantum state (where k is a positive integer equal to or greater than 1) into a k+1 level intermediate quantum state by applying the Y-axis rotation gate to two qubits, among a plurality of qubits representing the k-level output quantum state, and the second transformation unit may transform the k+1 level intermediate quantum state into a k+1 level output quantum state by applying the swap gate to a plurality of qubits representing the k+1 level intermediate quantum state, the k+1 level output quantum state being a state in which a k+1 level sub-image quantum state, corresponding to each of a plurality of k+1 level sub-images, and a quantum state, corresponding to a label for the k+1 level sub-image quantum state, are entangled with each other.

The apparatus may further include: a measurement unit configured to measure a state of a label qubit representing a quantum state corresponding to a label for a k-level sub-image (where k is a positive integer equal to or greater than 1); and a determination unit configured to determine whether a measured value of the label qubit is a preset value. The first transformation unit may transform a k-level output quantum state into a k+1 level intermediate quantum state by applying the Y-axis rotation gate to two qubits, among a plurality of qubits representing the k-level output quantum state, when the measured value of the label qubit is the preset value, and the second transformation unit may transform the k+1 level sub-image quantum state into a k+1 level output quantum state by applying the swap gate to a plurality of qubits representing the k+1 level intermediate state, the k+1 level output quantum state being a state in which a k+1 level sub-image quantum state, corresponding to a plurality of k+1 level sub-image, and a quantum state, corresponding to a label for the k+1 level sub-image quantum state, are entangled with each other.

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a diagram illustrating a configuration of an image conversion apparatus according to an example embodiment.

FIG. 2 is a diagram illustrating a pixel value of each pixel in an original image.

FIG. 3 is a diagram illustrating an example of an original image and a plurality of 1-level sub-images.

FIG. 4 is a diagram illustrating an example of an image conversion process according to an example embodiment.

FIG. 5 is a diagram illustrating a configuration of an image conversion apparatus according to an additional embodiment.

FIG. 6 is a diagram illustrating an example of an image conversion process according to an additional embodiment.

FIG. 7 is a diagram illustrating a configuration of an image conversion apparatus according to an additional embodiment.

FIG. 8 is a diagram illustrating an example of an image conversion process according to an additional embodiment.

FIG. 9 is a flowchart illustrating an image conversion method according to an example embodiment.

FIG. 10 is a block diagram illustrating a computing environment including a computing device according to an example embodiment.

### DETAILED DESCRIPTION

Hereinafter, embodiments of the present disclosure will be described in detail with reference to the accompanying drawings. The following detailed description is provided for comprehensive understanding of methods, devices, and/or systems described herein. However, the methods, devices, and/or systems are merely examples, and the present disclosure is not limited thereto.

In the following description, a detailed description of well-known functions and configurations incorporated herein will be omitted when it may obscure the subject matter of the present disclosure. Further, the terms used throughout this specification are defined in consideration of the functions of the present disclosure, and can be varied according to a purpose of a user or manager, or precedent and so on. Therefore, definitions of the terms should be made on the basis of the overall context. It should be understood that the terms used in the detailed description should be considered in a description sense only and not for purposes of limitation. Any references to singular may include plural unless expressly stated otherwise. In the present specification, it should be understood that the terms, such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

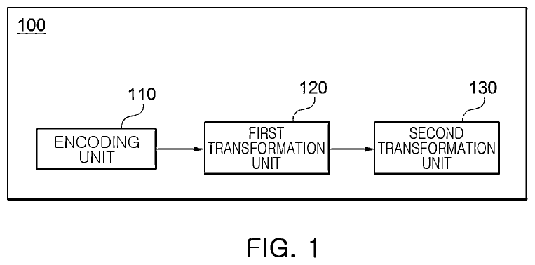

FIG. 1 is a diagram illustrating a configuration of an image conversion apparatus according to an example embodiment.

Referring to FIG. 1, an image conversion apparatus 100 according to an example embodiment may include an encoding unit 110, a first transformation unit 120, and a second transformation unit 130.

The image conversion apparatus 110 may be an apparatus for performing Haar wavelet transformation on an original image, a two-dimensional image, using a quantum circuit.

According to an example embodiment, the encoding unit 110, the first transformation unit 120, and the second transformation unit 130 may be implemented through at least one type of quantum computing hardware for storing a qubit or performing an operation using a qubit, or may be implemented through at least one type of classical computing hardware and at least one type of quantum computing hardware for storing a classical bit or performing an operation using a classical bit. In addition, the encoding unit 110, the first transformation unit 120, and the second transformation unit 130 may not be clearly distinguished in specific operations, unlike the illustrated example embodiment.

The encoding unit 110 may generate an input quantum state, corresponding to the original image, based on a pixel value of each pixel in the original image.

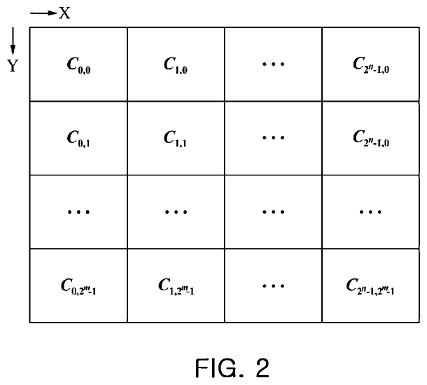

According to an example embodiment, the encoding unit 110 may generate an input quantum state, corresponding to the original image, through amplitude encoding based on a plurality of qubits corresponding to coordinates of each pixel in the original image and a pixel value of each pixel in the original image. For example, as in the example illustrated in FIG. 2, when the original image includes 2ⁿ×2^{m} pixels, the encoding unit 110 may generate an input quantum state corresponding to the original image by allowing a normalized pixel value of each pixel in the original image to be a probability amplitude of a computational basis, representing an X-axis coordinate value and a Y-axis coordinate value, through amplitude encoding.

For example, when states of n qubits corresponding to the X-axis coordinates of the original image (hereinafter referred to as “X-qubits”) are represented as |i₀>|i₁>|. . . |iₙ₋₁>=|x=i₀+2i₁+ . . . >=|x> and states of m qubits corresponding to the Y-axis coordinates of the original image (hereinafter referred to as “Y-qubits”) are represented as |j₀>|j₁>|. . . |jₘ₋₁>=|y=j₀+2j₁+ . . . >=|y> (where |i> and |j> are computational bases of i, j∈{0,1}, respectively), the input quantum state generated through amplitude encoding is given by the following Equation 1.

$$\vert {ψ}_{i n} 〉 = \frac{1}{N} {\sum }_{x = 0}^{{2}^{n} - 1} {\sum }_{y = 0}^{{2}^{m} - 1} {C}_{x , y} \vert x 〉 \vert y 〉 \qquad Equation 1$$

In Equation 1, |Ψᵢₙ> is an input quantum state, C_{x, y} is a pixel value of a pixel in which the X-axis coordinates is x and Y-axis coordinates is y in the original image (for example, color or brightness of the pixel), and N is a value for normalizing the input quantum state to be 1 in size.

The first transformation unit 120 may transform the input quantum state into a 1-level intermediate quantum state by applying a Y-axis rotation gate (Ry gate) to two qubits, among a plurality of qubits representing the input quantum state.

For example, as described above, the plurality of qubits representing the input quantum state may include a plurality of X-qubits, corresponding to the X-axis coordinates of each pixel in the original image, and a plurality of Y-qubits corresponding to the Y-axis coordinates of each pixel in the original image, and the first transformation unit 120 may rotate a state of each of one of the plurality of X-qubits and one of the plurality of Y-qubits by −π/2 about Y-axis of a Bloch sphere using a Y-axis rotation gate.

In this case, according to an example embodiment, the X-qubit and the Y-qubit having states rotated by the Y-axis rotation gate may be a last X-qubit, among the plurality of X-qubits, and a last Y-qubit, among the plurality of Y-qubits, respectively.

The second transformation unit 130 may transform the 1-level intermediate quantum state into a 1-level output quantum state by applying a swap gate to a plurality of qubits, representing the 1-level intermediate quantum state. In this case, the 1-level output quantum state may be a state in which a 1-level sub-image quantum state, corresponding to each of the plurality of 1-level sub-images generated by applying Harr wavelet transformation into the original image, and a quantum state, corresponding to a label for the 1-level sub-image, are entangled with each other.

The swap gate may be a quantum circuit swapping states of two qubits, and basis vector |i1>|i2> may be converted into |i₂>|i₁> through the swap gate Ŝ, as illustrated in the following Equation 2.

Ŝ|i₁ [symbol] |i₂ [symbol] =|i₂ [symbol] |i₁ [symbol] Equation 2

According to an example embodiment, the second transformation unit 130 may swap states of adjacent X-qubits from a last X-qubit to a first X-qubit, to which a Y-axis rotation gate is applied, among the plurality of qubits representing the 1-level intermediate quantum state, using the swap gate and may swap states of adjacent X-qubits from a last Y-qubit to a first Y-qubit, to which a Y-axis rotation gate is applied, among the plurality of qubits representing the 1-level intermediate quantum state, using the swap gate. Then, the second transformation unit 130 may swap the states of the first Y-qubit and the last X-qubit and then sequentially swap states of adjacent X-qubits from the last X-qubit to a second X-qubit, using the swap gate, to transform a 1-level intermediate quantum state into a 1-level output quantum state.

Accordingly, the second transformation unit 130 may spread a result of applying the Y-axis rotation gate to other qubits, representing the 1-level intermediate quantum state, and may simultaneously cause a 1-level sub-image quantum state, corresponding to each of a plurality of 1-level sub-images, and a quantum state, corresponding to a label for the 1-level sub-image quantum state, to be entangled with each other.

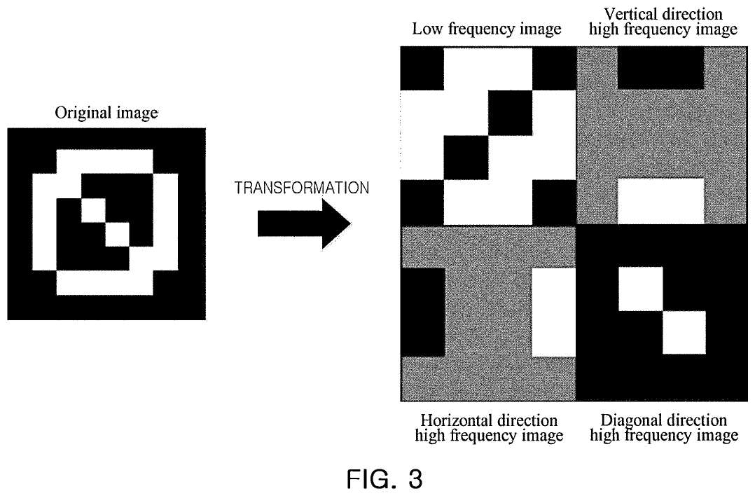

The plurality of 1-level sub-images may include a low-frequency image, a vertical direction high-frequency image, a horizontal direction high-frequency image, and a diagonal direction high-frequency image for the original image, as in the example illustrated in FIG. 3. In this case, when a size of the original image is 2ⁿ×2^{m}, a size of each of the plurality of 1-level sub-images may be 2ⁿ−1×2^{m-1}.

When a quantum state corresponding to the low-frequency image is |B>, a quantum state corresponding to the vertical direction high-frequency image is |V>, a quantum state corresponding to the horizontal direction high-frequency image is |H>, and a quantum state corresponding to the diagonal direction high-frequency image is |D>, |B>, |V>, |H>, and |D> may be represented by the following Equations 3 to 6.

$$\vert B 〉 = \frac{1}{{N}_{B}} {\sum }_{x = 0}^{{2}^{n - 1}} {\sum }_{y = 0}^{{2}^{m - 1}} {b}_{x , y} \vert x 〉 \vert y 〉 \qquad Equation 3$$

$$\vert V 〉 = \frac{1}{{N}_{V}} {\sum }_{x = 0}^{{2}^{n - 1}} {\sum }_{y = 0}^{{2}^{m - 1}} {v}_{x , y} \vert x 〉 \vert y 〉 \qquad Equation 4$$

$$\vert H 〉 = \frac{1}{{N}_{H}} {\sum }_{x = 0}^{{2}^{n - 1}} {\sum }_{y = 0}^{{2}^{m - 1}} {h}_{x , y} \vert x 〉 \vert y 〉 \qquad Equation 5$$

$$\vert D 〉 = \frac{1}{{N}_{D}} {\sum }_{x = 0}^{{2}^{n - 1}} {\sum }_{y = 0}^{{2}^{m - 1}} {d}_{x , y} \vert x 〉 \vert y 〉 \qquad Equation 6$$

In the above Equations 3 to 6, N_{B}, N_{V}, N_{H}, and N_{D} are values for normalizing the quantum states |B>, |V>, |H>, and |D> to have a size of 1, respectively, and b_{x, y}, v_{x, y}, h_{x, y}, and d_{x, y} may satisfy the following Equations 7 to 10.

b_{x,y}=(c_{x,y}+c_{x,y+1}+c_{x+1,y}+c_{x+1,y+1})/4 Equation 7

v_{x,y}=(−c_{x,y}+c_{x,y+1}−c_{x+1,y}+c_{x+1,y+1})/4 Equation 8

h_{x,y}=(−c_{x,y}−c_{x,y+1}+c_{x+1,y}+c_{x+1,y+1})/4 Equation 9

d_{x,y}=(c_{x,y}−C_{x,y+1}−c_{x+1,y}+c_{x+1,y+1})/4 Equation 10

The quantum state, corresponding to the label for the 1-level sub-image quantum state, may be a state of last two Y-qubits (hereinafter, referred to as “label qubits”), among the plurality of qubits.

The 1-level output quantum state |Ψₒᵤₜ>_{1 level} may be represented as an entangled state between the 1-level sub-image quantum state, corresponding to each of the plurality of 1-level sub-images, and the state of the label qubit, as illustrated in the following Equation 11.

|Ψₒᵤₜ [symbol] _{1 level}=|B [symbol] |00 [symbol] _{label}+|V)|01 [symbol] _{label}+|H [symbol] |10 [symbol] _{label}+|D [symbol] |11 [symbol] _{label} Equation 11

Accordingly, the 1-level output quantum state may be one of the states |B>, |V>, |H>, and |D> according to a classical bit value, a measurement value of a label qubit with a computational basis, as illustrated in Table 1.

TABLE 1

| Measurement Value of label qubit | 1-level output quantum state |
|---|---|
| 00 | \| B> |
| 01 | \| V> |
| 10 | \| H> |
| 11 | \| D> |

For example, the 1-level output quantum state becomes |B> when the measured value of the label qubit is 00, |V> when the measurement value is 01, |H> when the measurement value is 10, and |D> when the measurement value is 11, so that the measurement value of the label qubit may function as a label to identify whether the 1-level output quantum state is a quantum state corresponding to which of the plurality of 1-level sub-images.

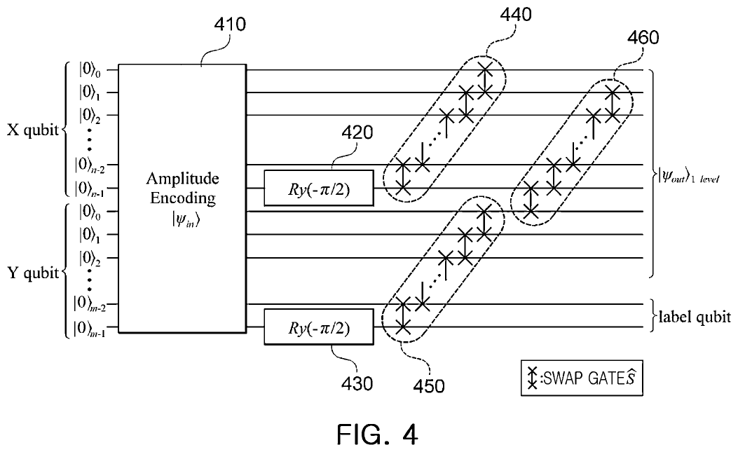

FIG. 4 is a diagram illustrating an image conversion process according to an example embodiment.

Referring to FIG. 4, the encoding unit 110 may perform amplitude encoding (410), using a plurality of qubits including n X-qubits corresponding to the X-axis coordinates of the original image and m Y-qubits corresponding to the Y-axis coordinates of the original image and a pixel value of each pixel in the original image, to generate an input quantum state |Ψᵢₙ>.

Then, the first transformation unit 120 may to transform the input quantum state |Ψᵢₙ> into the 1-level intermediate quantum state by rotating a state of each of an n-1-th X-qubit, a last X-qubit among the n X-qubits, and an m-1-th Y-qubit, a last Y-qubit among the m Y-qubits, by −π/2 about a Y-axis of a Bloch sphere using Y-axis rotation gates (420 and 430).

Then, the second transformation unit 130 may sequentially swap states of adjacent X-qubits from an n-1-th X-qubit to a 0-th X-qubit using the swap gate (440), and may sequentially swap states of adjacent Y-qubits from a m-1-th Y-qubit to a 0-th Y-qubit (450). Then, the second transformation unit 130 may swap the states of the 0-th Y-qubit and the n-1-th X-qubit, and may then sequentially swap states of adjacent X-qubits from the n-1-th X-qubit to a first X-qubit (460) to generate a 1-level output quantum state |Ψₒᵤₜ>_{1 level}. In this case, the 1-level output quantum state |Ψₒᵤₜ>_{1 level} may be state in which a 1-level sub-image quantum state, corresponding to each of the plurality of 1-level sub-images, and a label queue, including an m-1-th Y-qubit and an m-2-th Y-qubit, are entangled with each other.

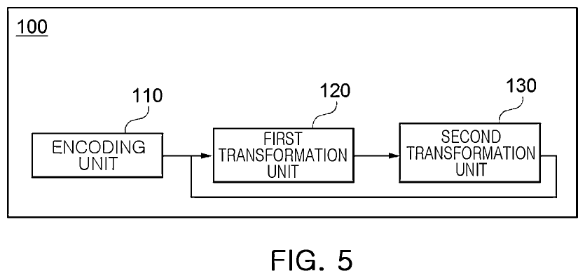

FIG. 5 is a diagram illustrating a configuration of an image conversion apparatus according to an additional embodiment.

Referring to FIG. 5, after the second transformation unit 130 generate the 1-level output quantum state, the first transformation unit 120 may transform a k-level output quantum state (where k is a positive integer equal to or greater than 1) into a k+1 level intermediate quantum state and the second transformation unit 130 may transform the k+1 level intermediate quantum state into a k+1 level output quantum state.

For example, the first transformation unit 120 may transform the k-level output quantum state into the k+1 level intermediate quantum state by applying the Y-axis rotation gate to two qubits, among a plurality of qubits representing the k-level output quantum state.

In addition, the second transformation unit 130 may transform the k+1 level intermediate quantum state into a k+1 level output quantum state by applying a swap gate to a plurality of qubits representing the k+1 level intermediate quantum state. In this case, the k+1 level output quantum state may be a state in which the k+1 level sub-image quantum state, corresponding to each of the plurality of k+1 level sub-images, and the quantum state, corresponding to the label for the k+1 level sub-image quantum state, are entangled with each other.

For example, the plurality of k+1 level sub-images may include a low-frequency image, a vertical high-frequency image, a horizontal high-frequency image, and a diagonal high-frequency image for each of the plurality of k-level sub-images. For example, the plurality of k+1 level sub-images may be 4k+1 sub-images. Accordingly, the number of the quantum states of the k+1 level sub-images, corresponding to each of the plurality of k+1 level sub-images, may also be 4k+1. In addition, the k+1 level output quantum state may be a state in which the states of 4k+1 k+1 level sub-image quantum states and states of 2 (k+1) label qubits are entangled with each other.

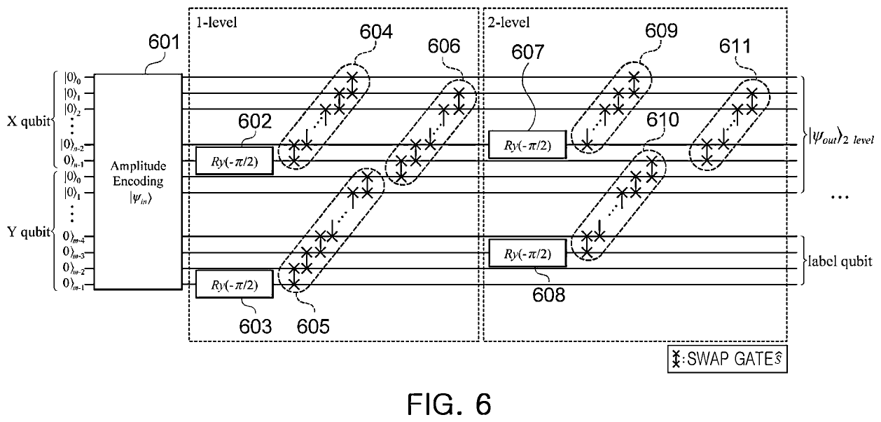

FIG. 6 is a diagram illustrating an image conversion process according to an additional embodiment.

For example, FIG. 6 illustrates a process of generating output quantum states of two or more levels based on a 1-level output quantum state.

In the example illustrated in FIG. 6, amplitude encoding 601 for generating an input quantum state and operations 602, 603, 604, 605, and 606 performed to generate a 1-level output quantum state |Ψₒᵤₜ>_{1 level} are the same as those of the example illustrated in FIG. 4, and thus overlapping descriptions thereof will be omitted.

As described above, when the size of the original image is 2ⁿ×2^{m}, a size of the 1-level sub-image is 2ⁿ⁻¹×2^{m-1}. Therefore, in the example illustrated in FIG. 6, among a plurality of qubits representing the 1-level output quantum state |Ψₒᵤₜ>_{1 level} (for example, the other qubits other than the m-1-th Y-qubit and the m-2-th Y-qubit), qubits corresponding to the X-axis coordinates of the 1-level sub-image may be n-1 qubits including the 0-th X-qubit to an n-2-th X-qubits, and qubits corresponding to the Y-axis coordinates of the 1-level sub-image may be m−1 qubits including the n-1-th X-qubit to an m-3-th Y-qubit.

Hereinafter, for ease of description, the n−1 qubits including the 0-th X-qubit to the n-2-th X-qubits will be referred to as 1-level X-qubits, and the m−1 qubits including the n-1-th X-qubit to the m-3-th Y-qubit will be referred to as a plurality of 1-level Y-qubits.

Referring to FIG. 6, the first transformation unit 120 may transform the 1-level output quantum state |Ψₒᵤₜ>_{1 level} into a 2-level intermediate quantum state by rotating a state of each of a last qubit among n-1 1-level X-qubits (for example, an n-2-th X-qubit) and a last qubit among m-1 1-level Y-qubits (for example, an n-3-th Y-qubit) by −π/2 about a Y-axis of a Bloch sphere.

Then, the second transformation unit 130 may sequentially swap states of adjacent qubits from the last qubit to the first qubit, among the n-1 1-level X-qubits, using a swap gate (609), and may sequentially swap states of adjacent qubits from the last qubit to the first qubit, among the m-1 1-level Y-qubits, using the swap gate (610). Then, the second transformation unit 130 may swap the state of the first qubit, among the m-1 1-level Y-qubits, and the last qubit, among n-1 1-level X-qubits, and may then sequentially swap adjacent qubits from a last qubit to a second qubit, among the n-1 1-level X-qubits (611). Thus, the second transformation unit 130 may be generate a 2-level output quantum state |Ψₒᵤₜ>_{2 level} in which a 2-level sub-image quantum state, corresponding to each of the plurality of two-level sub-images, and states of four label qubits, including an m-4-th Y-qubit in the m-1-th Y-qubit, are entangled with each other.

For example, when quantum states respectively corresponding to the plurality of 1-level sub-images are represented as B>, |V>, |H>, and |D>, quantum states respectively corresponding to the plurality of 2-level sub-images may be represented as 16 quantum states including BB>, |BV>, |BH>, |BD>, |VB>, |VV>, |VH>, |VD>, |HB>, |HV>,|HH>, |HD>, |DB>, |DV>, |DH>, and |DD>. The 2-level output quantum state |Ψₒᵤₜ>_{2 level} may be represented by the following Equation 12.

|Ψₒᵤₜ [symbol] _{2 level}=|BB [symbol] |0000 [symbol] _{label}+|BV [symbol] |0001 [symbol] _{label}+. . . +|DH [symbol] |1110 [symbol] _{label}+|DD [symbol] |1111 [symbol] _{label} Equation 12

Accordingly, the 2-level output quantum state Ψₒᵤₜ>_{2 level} may be one of BB>, |BV>, |BH>, |BD>, |VB>, |VV>, |VH>, |VD>, |HB>, |HV>, |HH>, |HD>, |DB>, |DV>, |DH>, and |DD> according to a 4-bit classical bit value, a measurement value obtained by measuring four label qubits with a computational basis. In addition, a 4-bit label qubit measurement value functions as a label to identify whether the two-level output quantum state is a quantum state corresponding to which of the plurality of two-level sub-images.

According to an example embodiment, the first transformation unit 120 and the second transformation unit 130 may repeatedly perform a process of generating an L−1 level output quantum state |Ψₒᵤₜ>_{L+1 level} using an L-level output quantum state (where L is a positive integer equal to or greater than 2) to a 3-level or higher output quantum state, in the same manner as the 2-level output quantum state |Ψₒᵤₜ>_{2 level} using the 1-level output quantum state |Ψₒᵤₜ>_{1 level}. In this case, the L+1 level output quantum state may be a state in which 4L+1 (L+1)-level sub-quantum states, including a quantum state corresponding to each of 4L+1 (L+1) -level sub-images, and states of 2 (L+1) label qubits are entangled with each other.

For example, when the size of the original image is 2ⁿ×2^{m}, a size of the L-level sub-image maybe 2ⁿ⁻¹×2^{m-L}. Accordingly, the L-level output quantum state |Ψₒᵤₜ>_{L level} may be represented by n−1 L-level X-qubits, including a 0-th L-level X-qubit to an n-L-1-th L-level X-qubit, and m-L L-level Y-qubits including a 0-th L-level Y-qubit to an m-L-1-th L-level Y-qubit. In this case, the first transformation unit 120 may transform the L-level output quantum state |Ψₒᵤₜ>_{L level} into an L-level intermediate quantum state by rotating a state of each of a last qubit, among the n-L L-level X-qubits, and a last qubit, among m-L L-level Y-qubits, by −π/2 about a Y-axis of a Bloch sphere using a Y-axis rotation gate.

Then, the second transformation unit 130 may sequentially swap states of adjacent qubits from a last qubit to a first qubit, among the n-L L-level X-qubits, using a swap gate, and may sequentially swap states of adjacent qubits from a last qubit to a first qubit, among the m-L L-level Y-qubits, using the swap gate. Then, the second transformation unit 130 may swap a state of the first qubit, among the m-L L-level Y-qubits, and a state of the last qubit, among the n-L L-level X-qubits, and may then sequentially swap states of adjacent qubits from a last qubit to a second qubit, among the n-L L-level X-qubits. Thus, the second transformation unit 130 may generate an (L+1)-level output quantum state |Ψₒᵤₜ>_{L+1 level} in which 4L+1 (L+1)-level sub-image quantum states, respectively corresponding to 4L+1 (L+1) -level sub-images, and states 2 (L+1) label qubits are entangled with each other.

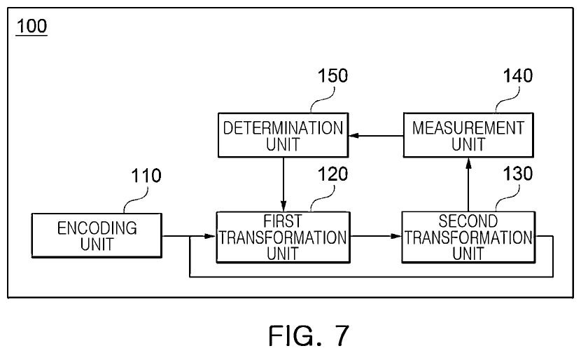

FIG. 7 is a diagram illustrating a configuration of an image conversion apparatus according to an additional embodiment.

Referring to FIG. 7, an image conversion apparatus 100 according to an additional embodiment may further include a measurement unit 140 and a determination unit 150.

When a k-level output quantum state is generated by a second transformation unit 130, the measurement unit 140 may measure a state of a label qubit representing a quantum state corresponding to a label for a k-level sub-image quantum state. The determination unit 150 may determine whether a measurement value of the label qubit measured by the measurement unit 140 is a preset value. Only when the measurement value is the preset value, a first transformation unit 130 and the second transformation unit 130 may control a k-level output quantum state (where k is a positive integer equal to or greater than 1) to be transformed into a k+1 level output quantum state. To this end, according to an example embodiment, the determination unit 150 maybe implemented through one or more types of classical computing hardware. In addition, according to an example embodiment, the preset value may correspond to a label for a quantum state corresponding to a low-frequency sub-image among k-level sub-images.

When the measurement value of the label qubit measured by the measurement unit 140 is the preset value, the first transformation unit 130 may transform the k-level output quantum state into a k+1 level intermediate quantum state and the second transformation unit 130 may transform the k+1 level intermediate quantum state into the k+1 level output quantum state.

For example, the first transformation unit 120 may transform the k-level output quantum state into the k+1 level intermediate quantum level by applying a Y-axis rotation gate to two qubits among a plurality of qubits representing the k-level output quantum state. In addition, the second transformation unit 130 may transform the k+1 level intermediate quantum state into a k+1 level output quantum state by applying a swap gate to a plurality of qubits representing the k+1 level intermediate quantum state. In this case, the k+1 level output quantum state may be a state in which the k+1 level sub-image quantum state, corresponding to each of the plurality of k+1 level sub-images, and quantum states, corresponding to a label for the k+1 level sub-image quantum state, are entangled with each other.

For example, the plurality of k+1 level sub-images may include a low-frequency image, a vertical direction high-frequency image, a horizontal direction high-frequency image, and a diagonal direction high-frequency image for a specific sub-image (for example, a low-frequency image) among the plurality of k-level sub-images. For example, the plurality of k+1 level sub-images maybe four sub-images, and accordingly, the number of quantum states of the k+1 level sub-images, respectively corresponding to the plurality of k+1 level sub-images, may also be four. In addition, the k+1 level output quantum state may be a state in which the four k+1 level sub-image quantum states and states 2 (k+1) label qubits are entangled with each other.

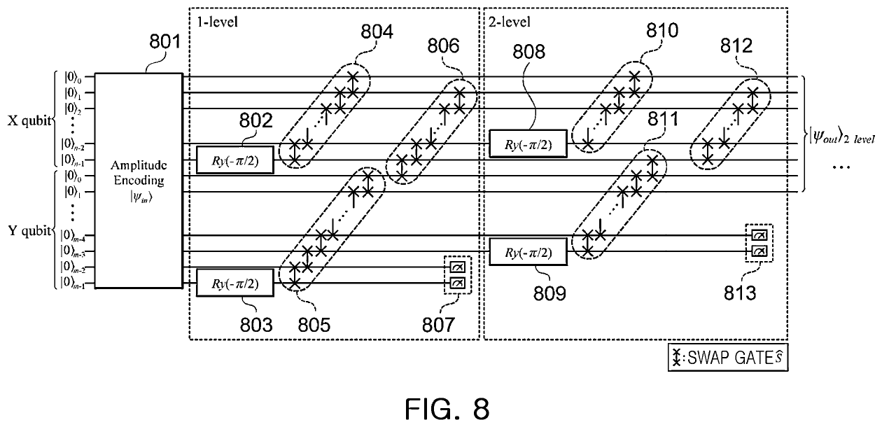

FIG. 8 is a diagram illustrating an image conversion process according to an additional embodiment.

For example, FIG. 8 illustrates a process of generating a 2-level or higher output quantum state only when a 1-level output quantum state is a quantum state corresponding to a low-frequency sub-image, among a plurality of 1-level sub-images.

In the example illustrated in FIG. 8, amplitude encoding 801 for generating an input quantum state and operations 802, 803, 804, 805, and 806 performed to generate a 1-level output quantum state |Ψₒᵤₜ>_{1 level} are the same as those of the example illustrated in FIG. 4, and thus overlapping descriptions thereof will be omitted.

Referring to FIG. 8, the measurement unit 140 may measure a state of a label qubit when a 1-level output quantum state |Ψₒᵤₜ>_{1 level} is generated by a second transformation unit 130 (807).

Then, the determination unit 150 may determine whether a measured value of the label qubit is a value (for example, “00”) denoting a label for a quantum state corresponding to a low-frequency image. In this case, when the measured value of the label qubit is not “00,” the determination unit 150 may control a first transformation unit 120 and the second transformation unit 130 to not perform an operation for generating a 2-level output quantum state. Meanwhile, when the measured value is “00,” the determination unit 150 may control the first transformation unit 120 and the second transformation unit 130 to generate a 2-level output quantum state using the 1-level output quantum state. In this case, the operations 808, 809, 810, 811, and 812 performed to generate the 2-level output quantum state |Ψₒᵤₜ>_{2 level} are the same as those of the example illustrated in FIG. 6, and thus redundant descriptions thereof will be omitted.

As in the example illustrated in FIG. 8, the first transformation unit 120 and the second transformation unit 130 may be controlled to generate the 2-level output quantum state |Ψₒᵤₜ>_{2 level} only when the measured value of the label qubit is “00.” In this case, the 2-level output quantum state |Ψₒᵤₜ>_{2 level} maybe represented by the following Equation 13. This means that, when the 1-level output quantum state is |V>, |H>, and |D>, an operation for generating a 2-level output quantum state is not performed by the first transformation unit 120 and the second transformation unit 130.

$${{{{{{{{\vert {ψ}_{out} 〉 〈 {ψ}_{out} \vert}_{2 - level} = \vert BB 〉 〈 BB \vert ⊗ \vert 0000 〉 〈 0000 \vert}_{label} + \vert BV 〉 〈 BV \vert ⊗ \vert 0001 〉 〈 0001 \vert}_{label} + \vert BH 〉 〈 BH \vert ⊗ \vert 0010 〉 〈 0010 \vert}_{label} + \vert BD 〉 〈 BD \vert ⊗ \vert 0011 〉 〈 0011 \vert}_{label} + \vert V 〉 〈 V \vert ⊗ \vert 01 〉 〈 01 \vert}_{label} + \vert H 〉 〈 H \vert ⊗ \vert 10 〉 〈 10 \vert}_{label} + \vert D 〉 〈 V \vert ⊗ \vert 11 〉 〈 11 \vert}_{label}$$

In Equation 13, ⊗ refers to a tensor product.

Accordingly, the 2-level output quantum state |Ψₒᵤₜ>_{2 level} may be one of |BB>, |BV>, |BH>, |BD>, |VB>, |VV>, |VH>, |VD>, |HB>, |HV>, |HH>, |HD>, |DB>, |DV>, |DH>, and |DD> according to a 4-bit classical bit value, a measurement value obtained by measuring four label qubits with a computational basis. In addition, the 4-bit label qubit measurement value may function as a label to identify whether the 2-level output quantum state is a quantum state corresponding to which of the plurality of 2-level sub-images.

According to an example embodiment, the determination unit 150 may determine whether, after the 2-level output quantum state |Ψₒᵤₜ>_{2 level} is generated, a measured value for four label qubits is a value (for example, “000”) representing a label for a quantum state corresponding to a low-frequency image. In this case, when the measured value of the label qubit is not “0000” (for example, when the 2-level output quantum state |Ψₒᵤₜ>_{2 level} is not |BB>), the determination unit 150 may control the first transformation unit 120 and the second transformation unit 130 to not perform an operation of generating a three-level output quantum state. Meanwhile, when the measured value is “0000” (for example, when the 2-level output quantum state |Ψₒᵤₜ>_{2 level} is |BB>), the determination unit 150 may control the first transformation unit 120 and the second transformation unit 130 to generate a 3-level output quantum state |Ψₒᵤₜ>_{3 level} using the 2-level output quantum state. In this case, the 3-level output quantum state |Ψₒᵤₜ>_{3 level} may be generated through the same process as the above-described process of generating the L+1 level output quantum state |Ψₒᵤₜ>_{L+1 level}, and thus overlapping descriptions thereof will be omitted.

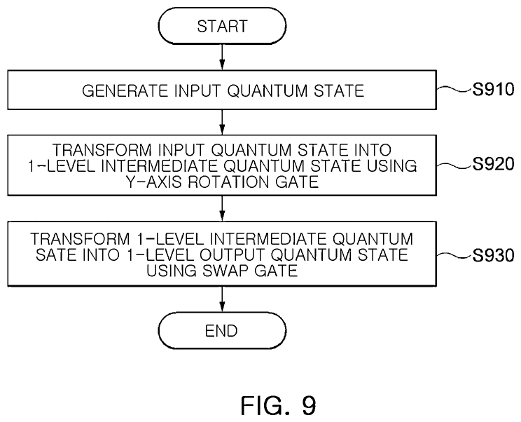

FIG. 9 is a flowchart illustrating an image conversion method according to an example embodiment.

The method illustrated in FIG. 9 may be performed by, for example, the image conversion apparatus 100 illustrated in FIG. 1.

Referring to FIG. 9, the image conversion apparatus 100 may generates an input quantum state corresponding to an original image, based on a pixel value of each pixel in the original image (S910).

Then, the image conversion apparatus 100 may transform an input quantum state into a 1-level intermediate quantum state by applying a Y-axis rotation gate to two qubits, among a plurality of qubits representing the input quantum state (S920).

Then, the image conversion apparatus 100 may transform the 1-level intermediate quantum state into a 1-level output quantum state by applying a swap gate to a plurality of qubits representing the 1-level intermediate quantum state (S930). In the 1-level output quantum state, a 1-level sub-image quantum state, corresponding to each of a plurality of 1-level sub-images, and a 1-level label quantum state, corresponding to the 1-level sub-image quantum state, are entangled with each other.

In the flowchart illustrated in FIG. 9, at least some operations may be performed in a different order, performed in combination with other operations, omitted, or subdivided and performed, or one or more operations which are not illustrated in the drawing may be additionally performed.

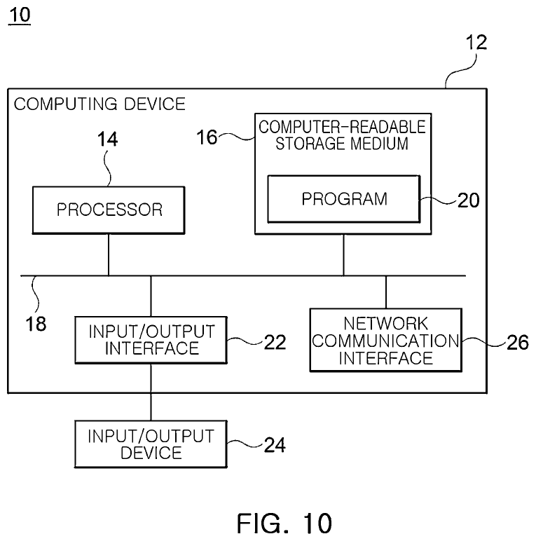

FIG. 10 is a block diagram illustrating a computing environment including a computing device according to an example embodiment. In the illustrated embodiment, each of the components may have functions and capabilities different from those described hereinafter and additional components may be included in addition to the components described herein.

The illustrated computing environment 10 may include a computing device 12. The computing device 12 maybe at least one component included in an image conversion apparatus 100 according to an example embodiment.

The computing device 12 may include at least one processor 12, a computer-readable storage medium 16, and a communication bus 18. The processor 14 may cause the computing device 12 to operate according to the above-described example embodiments. For example, the processor 14 may execute one or more programs stored in the computer-readable storage medium 16. The one or more programs may include one or more computer-executable commands, and the computer-executable commands maybe configured to, when executed by the processor 14, cause the computing device 12 to perform operations according to the example embodiment.

The computer-readable storage medium 16 may be configured to store computer-executable commands and program codes, program data and/or information in other suitable forms. The programs stored in the computer-readable storage medium 16 may include a set of commands executable by the processor 14. In an embodiment, the computer-readable storage medium 16 may be a memory (a volatile memory such as a random access memory (RAM), a nonvolatile memory, or a combination thereof), one or more magnetic disk storage devices, optical disk storage devices, flash memory devices, storage media in other forms capable of being accessed by the computing device 12 and storing desired information, or appropriate combinations thereof.

The communication bus 18 may connects various other components of the computing device 12 including the processor 14 and the computer-readable storage medium 16.

The computing device 12 may include one or more input/output interfaces 22 for one or more input/output devices 24 and one or more network communication interfaces 26. The input/output interface 22 and the network communication interface 26 maybe connected to the communication bus 18. The input/output device 24 may be connected to other components of the computing device 12 through the input/output interface 22. The illustrative input/output device 24 maybe a pointing device (a mouse, a trackpad, or the like), a keyboard, a touch input device (a touchpad, a touchscreen, or the like), an input device such as a voice or sound input device, various types of sensor device, and/or an image capturing device, and/or an output device such as a display device, a printer, a speaker, and/or a network card. The illustrative input/output device 24, a component constituting the computing device 12, may be included inside the computing device 12 or may be configured as a separate device from the computing device 12 and connected to the computing device 12.

As described above, an input quantum state corresponding to an original image may be generated, and an output quantum state, in which quantum states for sub-images generated through Harr wavelet transformation using a Y-axis rotation gate and a swap gate and quantum states of labels corresponding to the quantum states for sub-images are entangled with each other, may be generated. Accordingly, unlike the related art, a quantum state for a label may be measured to identify which sub-image the output quantum state represents, and an inter-dimensional operation may be performed.

While example embodiments have been shown and described above, it will be apparent to those skilled in the art that modifications and variations could be made without departing from the scope of the present disclosure as defined by the appended claims.

What is claimed is:

1. A method for converting an image using a quantum circuit, the method comprising:
generating an input quantum state corresponding to an original image, based on a pixel value of each pixel in the original image;
transforming the input quantum state into a 1-level intermediate quantum state by applying a Y-axis rotation gate to two qubits among a plurality of qubits representing the input quantum state; and
transforming the 1-level intermediate quantum state into a 1-level output quantum state by applying a swap gate to a plurality of qubits representing the 1-level intermediate quantum state, the 1-level output quantum state being a state in which a 1-level sub-image quantum state, corresponding to each of a plurality of 1-level sub-images generated by applying Harr wavelet transformation to the original image, and a quantum state, corresponding to a label for the 1-level sub-image quantum state, are entangled with each other.

2. The method of claim 1, wherein, the generating of the input quantum state comprises generating the input quantum state through amplitude encoding based on a plurality of qubits corresponding to coordinates of each pixel and the pixel value of each pixel.

3. The method of claim 1, wherein the plurality of 1-level sub-images includes a low-frequency image, a horizontal direction high-frequency image, a vertical direction high-frequency image, and a diagonal direction high-frequency image for the original image; and
the label for the 1-level sub-image quantum state is a label for identifying whether the 1-level sub-image quantum state is a quantum state corresponding to which image among the low-frequency image, the horizontal direction high-frequency image, the vertical direction high-frequency image, and the diagonal direction high-frequency image.

4. The method of claim 1, wherein the plurality of qubits representing the input quantum state include:
a plurality of X-qubits corresponding to X-axis coordinates of each pixel; and
a plurality of Y-qubits corresponding to Y-axis coordinates of each pixel.

5. The method of claim 4, wherein, in the transforming of the 1-level intermediate quantum state into the 1-level output quantum state, a state of each of one of the plurality of X-qubits and one of the Y-qubits rotates by −π/2 about a Y-axis of a Bloch sphere.

6. The method of claim 5, wherein, in the transforming of the 1-level intermediate quantum state into the 1-level output quantum state, a state of each of the last X-qubit, among the plurality of X-qubits, and the last Y-qubit, among the plurality of Y-qubits, rotates by −π/2 about the Y-axis of the Bloch sphere.

7. The method of claim 6, wherein the transforming of the 1-level intermediate quantum state into the 1-level output quantum state comprises:
sequentially swapping states of adjacent X-qubits from the last X-qubit to a first X-qubit, among the plurality of X-qubits;
sequentially swapping states of adjacent Y-qubits from the last Y-qubit to a first Y-qubit, among the plurality of Y-qubits; and
swapping states of the first Y-qubit and the last X-qubit, and then sequentially swapping states of adjacent X-qubits from the last X-qubit to a second X-qubit, among the plurality of X-qubits.

8. The method of claim 1, further comprising:
transforming a k-level output quantum state, where k is a positive integer equal to or greater than 1, into a k+1 level intermediate quantum state by applying the Y-axis rotation gate to two qubits, among a plurality of qubits representing the k-level output quantum state; and
transforming the k+1 level intermediate quantum state into a k+1 level output quantum state by applying the swap gate to a plurality of qubits representing the k+1 level intermediate quantum state, the k+1 level output quantum state being a state in which a k+1 level sub-image quantum state, corresponding to each of a plurality of k+1 level sub-images, and a quantum state, corresponding to a label for the k+1 level sub-image quantum state, are entangled with each other.

9. The method of claim 1, further comprising:
measuring a state of a label qubit representing a quantum state corresponding to a label for a k-level sub-image, where k is a positive integer equal to or greater than 1 to obtain a value of the label qubit;
determining whether the value of the label qubit is a preset value;
transforming a k-level output quantum state into a k+1 level intermediate quantum state by applying the Y-axis rotation gate to two qubits, among a plurality of qubits representing the k-level output quantum state, when the measured value of the label qubit is the preset value; and
transforming the k+1 level sub-image quantum state into a k+1 level output quantum state by applying the swap gate to a plurality of qubits representing the k+1 level intermediate state, the k+1 level output quantum state being a state in which a k+1 level sub-image quantum state, corresponding to a plurality of k+1 level sub-image, and a quantum state, corresponding to a label for the k+1 level sub-image quantum state, are entangled with each other.

10. An apparatus for converting an image using a quantum circuit, the apparatus comprising at least one processor, a computer-readable storage medium storing one or more programs including one or more computer-executable commands executed by the at least one processor, the one or more computer-executable commands implements operations for:
an encoding unit configured to generate an input quantum state corresponding to an original image, based on a pixel value of each pixel in the original image;
a first transformation unit configured to transform the input quantum state into a 1-level intermediate quantum state by applying a Y-axis rotation gate to two qubits, among a plurality of qubits representing the input quantum state; and
a second transformation unit configured to transform the 1-level intermediate quantum state into a 1-level output quantum state by applying a swap gate to a plurality of qubits representing the 1-level intermediate quantum state, the 1-level output quantum state being a state in which a 1-level sub-image quantum state, corresponding to each of a plurality of 1-level sub-images generated by applying Harr wavelet transformation to the original image, and a quantum state, corresponding to a label for the 1-level sub-image quantum state, are entangled with each other.

11. The apparatus of claim 10, wherein the encoding unit is configured to generate the input quantum state through amplitude encoding based on a plurality of qubits, corresponding to coordinates of each pixel, and the pixel value of each pixel.

12. The apparatus of claim 11, wherein the plurality of 1-level sub-images includes a low-frequency image, a horizontal direction high-frequency image, a vertical direction high-frequency image, and a diagonal direction high-frequency image for the original image; and
the label for the 1-level sub-image quantum state is a label for identifying whether the 1-level sub-image quantum state is a quantum state corresponding to which image among the low-frequency image, the horizontal direction high-frequency image, the vertical direction high-frequency image, and the diagonal direction high-frequency image.

13. The apparatus of claim 10, wherein the plurality of qubits representing the input quantum state include:
a plurality of X-qubits corresponding to X-axis coordinates of each pixel; and
a plurality of Y-qubits corresponding to Y-axis coordinates of each pixel.

14. The apparatus of claim 13, wherein the first transformation unit is configured to rotate a state of each of one of the plurality of X-qubits and one of the Y-qubits by −π/2 about a Y-axis of a Bloch sphere.

15. The apparatus of claim 14, wherein the first transformation unit is configured to rotate a state of each of the last X-qubit, among the plurality of X-qubits, and the last Y-qubit, among the plurality of Y-qubits, by −π/2 about the Y-axis of the Bloch sphere.

16. The apparatus of claim 15, wherein the second conversion unit is configured to:
sequentially swap states of adjacent X-qubits from the last X-qubit to a first X-qubit, among the plurality of X-qubits;
sequentially swap states of adjacent Y-qubits from the last Y-qubit to a first Y-qubit, among the plurality of Y-qubits; and
swap states of the first Y-qubit and the last X-qubit, and then sequentially swaps states of adjacent X-qubits from the last X-qubit to a second X-qubit, among the plurality of X-qubits.

17. The apparatus of claim 10, wherein the first transformation unit is configured to transform a k-level output quantum state, where k is a positive integer equal to or greater than 1, into a k+1 level intermediate quantum state by applying the Y-axis rotation gate to two qubits, among a plurality of qubits representing the k-level output quantum state; and
the second transformation unit is configured to transform the k+1 level intermediate quantum state into a k+1 level output quantum state by applying the swap gate to a plurality of qubits representing the k+1 level intermediate quantum state, the k+1 level output quantum state being a state in which a k+1 level sub-image quantum state, corresponding to each of a plurality of k+1 level sub-images, and a quantum state, corresponding to a label for the k+1 level sub-image quantum state, are entangled with each other.

18. The apparatus of claim 10, further comprising:
a measurement unit configured to measure a state of a label qubit representing a quantum state corresponding to a label for a k-level sub-image, where k is a positive integer equal to or greater than 1, to obtain a value of the label quit; and
a determination unit configured to determine whether the value of the label qubit is a preset value,
wherein the first transformation unit is configured to transform a k-level output quantum state into a k+1 level intermediate quantum state by applying the Y-axis rotation gate to two qubits, among a plurality of qubits representing the k-level output quantum state, when the measured value of the label qubit is the preset value; and
the second transformation unit is configured to transform the k+1 level sub-image quantum state into a k+1 level output quantum state by applying the swap gate to a plurality of qubits representing the k+1 level intermediate state, the k+1 level output quantum state being a state in which a k+1 level sub-image quantum state, corresponding to a plurality of k+1 level sub-image, and a quantum state, corresponding to a label for the k+1 level sub-image quantum state, are entangled with each other.
